(19) United States
(12) Patent Application Publication
(10) Pub. No.: US 2010/0036943 A1
(43) Pub. Date: Feb. 11, 2010

(54) METHOD OF NETWORK MANAGEMENT

(75) Inventors: Shuji HOSOKAWA, Kawasaki (JP); Hiroaki Abe, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/537,309

(22) Filed: Aug. 7, 2009

(30) Foreign Application Priority Data
Aug. 7, 2008 (JP) 2008-204615

(51) Int. Cl. G06F 15/173

(52) U.S. Cl. 709/224

(57) ABSTRACT

A network management system comprises a unit for identifying a node, whose settings are to be modified, from design pattern information about a network to be managed; a unit for finding values of various timers included in the network management system and in the node whose settings are to be modified about the identified node based on a template for timer control; and a unit for causing the found values of the timers to be reflected simultaneously in the network management system and in the node whose settings are to be modified.

### CROSS-REFERENCE TO RELATED APPLICATION(S)

This application is based upon and claims the benefit of priority of the prior Japanese Patent Application No. 2008-204615, filed on Aug. 7, 2008, the entire contents of which are incorporated herein by reference.

### FIELD

The present invention relates to a method of network management.

### BACKGROUND

The monitoring of faults in network management is generally conducted using an operation manager installed in a network management system (NMS), a router forming the network, and an operation agent installed at a node (such as a hub or network element). When a fault such as a network break is detected, the operation agent sends an information message to the operation manager and a signal indicating the held status in response to polling periodically performed by the operation manager. Various timers including a timer for setting a timeout period (e.g., a fault detection time) for detection of faults are mounted for the detection of faults performed by the operation agent. Similarly, various timers including a timer for setting a timeout period (e.g., a status acquisition error detection time) for which the operation manager waits for a response from the operation agent are mounted for the operation manager. The values of these timers are dependent on each other. If the value of a timer is set too short, an erroneous detection would occur in spite of the fact that the system operates normally in practice. Conversely, if the value of the timer is set too long, it takes longer to detect generation of a fault. This will adversely affect corresponding actions taken subsequently. In the case of a simple network configuration, the time in which a fault is detected by the operation agent and the response time are determined substantially uniquely by the type of the node. Consequently, the values of the timers have been determined and held constant according to the type of the node.

In recent years, as the internet protocol (IP) technology has evolved, the building of large-scale private IP networks that are combinations of various carrier network services is in progress. In such a large-scale private IP network, even if nodes forming the network are of the same type, the timing of information messages and the response time from each node responsive to periodic polling from a network management system (NMS) are different depending on the network capacity and on settings of router priority control. Therefore, in such a large-scale private IP network, it is necessary to appropriately tune the values of various timers throughout the operation.

FIG. 1 schematically illustrates tuning performed using a PDCA cycle.

First, the timeout period (fault detection time) for detection of a fault and the timeout period for polling (status acquisition error detection time) are previously designed depending on the contents of services offered to the network user and on the node type and network capacity (P: Plan).

2) The designed values are used as parameters in monitoring a commercial network (D: Do).

3) Data indicated by information messages based on the results of the step 2) are totaled and checked (C: Check).

4) The results of the check are analyzed. An improvement plan is discussed (A: Act).

5) Data derived by the discussed improvement plan is fed back to the design (P).

Tuning is performed by this procedure using a PDCA cycle.

FIG. 2 schematically illustrates the manner in which a large-scale private IP network is monitored whether or not there is a fault. A logical link 3 exists between a node 2 being a customer edge on the center side and a node 4 being a customer edge on the user side. An operation manager 11 is installed in a network management system (NMS) 1 that is disposed in a monitoring center, and the operation manager acquires the status of an operation agent 41 installed in the node 4 by periodic polling. In the configuration of FIG. 2, the logical link 3 consists, for example, of a physical link 31, a carrier network 32, and a physical link 33. As IP-based networks have enjoyed wider acceptance, more diversified choices are offered to node connection configurations and inter-node networks. Inbound network connections in which an unspecified number of data items share a network with nodes have received wider acceptance. Furthermore, communications between the operation manager and the operation agent are performed utilizing such inbound connection.

The operation manager 11 of the network management system (NMS) 1 sends out SNMP (simple network management protocol) or telnet commands in a given sequence to the operation agent 41 of the node 4, thus performing operations such as configuration transfer or port control. The NMS 1 has a command catalog delivery portion 13 that delivers a catalog of commands to the node 4, the commands being used for controlling the operation of the node 4. The delivered command catalog is held in a system configuration setting file 42 in the node 4. The network is centrally monitored by periodically acquiring the status from the operation agent 41 of the node 4 by means of the operation manager 11 of the network management system 1 using SNMP or another protocol.

The relationship between the location at which a fault occurs and the detection of the fault or an error occurring in acquiring the status (hereinafter may be referred to as a “status acquisition error” is as follows. When a fault occurs in the operation agent 41 within the node 4 or another fault occurs at the node 4, a status acquisition error occurs in the operation manager 11 of the network management system 1 without detecting any fault. If a fault occurs either on the physical link 33 connected with the node 4 or on a single logical link connected with the node 4 (e.g., a fault on one link), the operation manager 11 of the management system 1 does not produce a status acquisition error but detects the fault on the physical link by being informed of the fault from the nodes 2 and 4. If a fault occurs on a redundant logical link connected to the node 4 (i.e., fault on both links), the operation manager 11 of the management system 1 produces a status acquisition error without detecting a fault from the node 4.

On the other hand, the network management system 1 sets a timer value into a timer setting file 12 in response to each individual manipulation or command according to the type of the node of the monitored network. This prevents the system from being in an operation response waiting state for a long time when a fault occurs at the node or in the network. A retry subroutine is also used to suppress frequent detection of errors on temporal communication failures. As described previously, in an IP network, even with the same node type in the same network, different responses are made to the same request according to the following parameters: (a) type of network used, (b) configuration of adjacent node, (c) circuit class, and (d) priority control level of the node for each individual kind of data.

FIGS. 3A and 3B illustrate the relationship between the node fault detection time and the state acquisition error detection time of the network management system 1. FIG. 3A illustrates the relationship among a physical link fault detection time (that is the node fault detection time), a single logical link fault detection time, and a logical link switching detection time. FIG. 3B illustrates the relationship between the monitoring timeout period of the network management system 1 regarding a fault on a single link and the monitoring timeout period regarding switching of a redundant logical link in a case where it is desired to set the monitoring timeout period longer than the node fault detection time. Because the timer settings of network management system (NMS) 1 and of the node are dependent on each other as can be seen from FIGS. 3A and 3B, it is necessary to make the settings as close together in time as possible. If a fault takes place after the settings of only one of the NMS and timer have been modified, it is difficult to locate the cause and time of the fault from the output message.

FIG. 4 is a flowchart illustrating a prior art fault monitoring subroutine, which is divided into a designing phase for monitoring, designing, and configuring a network, and an operation phase for monitoring and operating the network. The designing phase is divided into a set of preparatory tasks and a set of setting modification tasks.

In the set of preparatory tasks, patterns regarding various timers are designed (step S1) and data about the monitored node is registered into the network management system 1 (step S2). The designed patterns include various parameters such as machine type, vendor, physical link (capacity), logical link, used carrier network, conditions under which an access is made to the carrier network, redundant logical link, and scale (range) of the serviced configuration. In the set of setting modification task, the results of the design of the patterns are reflected in the timer setting file 12 when the network is configured (step S3).

Then, in the operation phase for monitoring and operating the network, fault statistical data produced by the monitoring subroutine is extracted (step S4). The results of the extracted statistical data are then evaluated and analyzed (step S5). Subsequently, the timer values are readjusted based on the results of the evaluation and analysis of the fault statistical data (step S6). For example, the timer values readjusted in step S6 are reflected by a manual tuning operation.

The prior art large-scale private IP network is monitored whether or not there is a fault as mentioned previously. However, the following problems exist:
(1) Where the timers are set in a machine model dependent manner, if a timeout occurs in the communication between the operation manager and the operation agent, an operation error occurs. This makes it impossible to monitor the network. Alternatively, the values of the timers are increased to their maximum values. This will lead to an excessively long operation waiting time.
(2) When a certain node type is operated, if an IP network in which network types having low speeds or priority control levels producing low speeds are nullified is employed, an unexpected communication timeout occurs even though the system should have been optimized using a main circuit class or a configuration pattern having a wide bandwidth.
(3) Where the timer value is set for the worst value, if a communication failure occurs due to an actual fault, a timeout is detected with a delay. This prolongs the operation waiting time.
(4) During the status acquisition subroutine, the network is polled at regular intervals of time and so the subroutine provides a means that is effective in measuring the quality of an end-to-end link.

However, the communication quality (response performance) varies depending on the bandwidth of a carrier-offering shared IP network, on the quality of each individual line, on timer settings for detection of router faults, or on the amount of configuration of the network outside a customer's edge. Therefore, the operation may not be monitored appropriately if only pre-designed timer values are used.

In consequence, a technique is desired which is capable of readjusting the relationship between a timer for detecting a status acquisition error in the network management system and a fault detection timer in the node with the least steps from the designing phase in a corresponding manner to various connection configuration considerations (such as configuration modification, elimination and consolidation, addition of other machine type, and utilization of carrier network which often occur in a large-scale private IP network).

Meanwhile, JP-A-9-149045 discloses a technique for monitoring and controlling a network using a network management system (NMS) but fails to disclose any technique for setting timer values for monitoring the network for faults as described previously.

In view of the foregoing problem with the prior art, it is an object of the present invention to provide a method of network management capable of strictly classifying faults by setting timer values appropriately for both a network management system and a node according to the network configuration.

### SUMMARY

A network management system comprises a unit for identifying a node, whose settings are to be modified, from design pattern information about a network to be managed; a unit for finding values of various timers included in the network management system and in the node whose settings are to be modified about the identified node based on a template for timer control; and a unit for causing the found values of the timers to be reflected simultaneously in the network management system and in the node whose settings are to be modified.

### BRIEF DESCRIPTION OF DRAWINGS

FIG. 1 is a schematic representation of a tuning operation using a PDCA cycle;

FIG. 2 is a schematic diagram illustrating monitoring of a large-scale private IP network for faults;

FIGS. 3A and 3B are diagrams illustrating the relationship between a node fault detection time and a status acquisition error detection time of a network management system;

FIG. 4 is a flowchart of the prior art fault monitoring subroutine;

FIG. 5 is a diagram illustrating an example of configuration of a system associated with one embodiment of the present invention;

FIG. 6 is a flowchart of a fault monitoring subroutine according to one embodiment of the invention;

FIG. 7 is a diagram illustrating an example of data structure of network configuration dataset;

FIG. 8 is a diagram illustrating an example of structure of a template used for timer control;

FIG. 9 is a flowchart illustrating an example of a routine for modifying settings;

FIG. 10 is a diagram illustrating an example of structure of a list regarding a node whose settings are to be modified;

FIG. 11 illustrates an example of structure of a system configuration setting file in a node;

FIG. 12 is a diagram illustrating an example of structure of a timer setting file within a network management system; and

FIGS. 13A-13C are diagrams illustrating an example of a routine executed when a timer value is set dynamically.

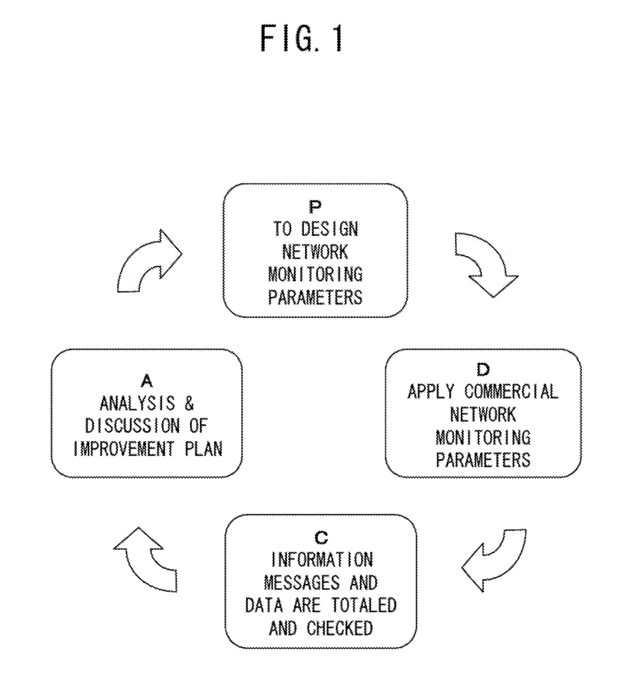

### DESCRIPTION OF EMBODIMENTS

The preferred embodiments of the present invention are hereinafter described.

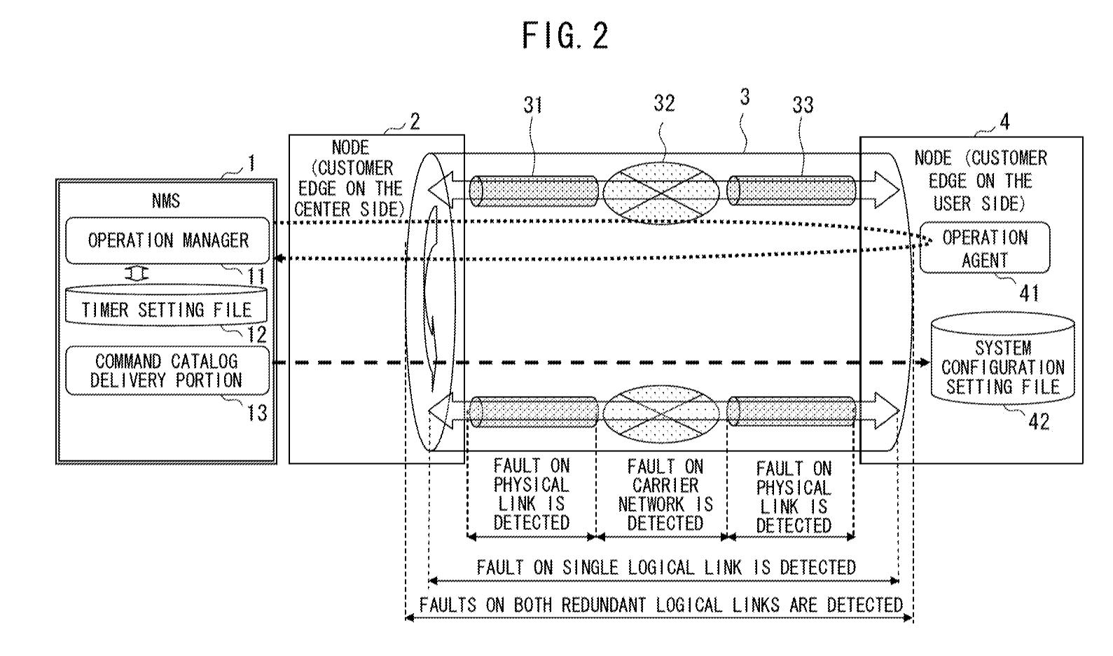

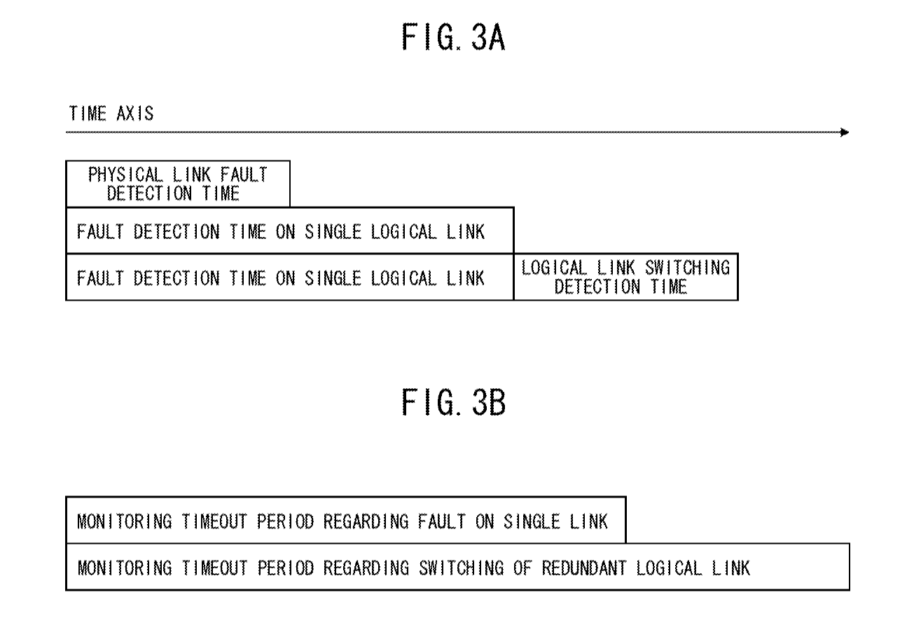

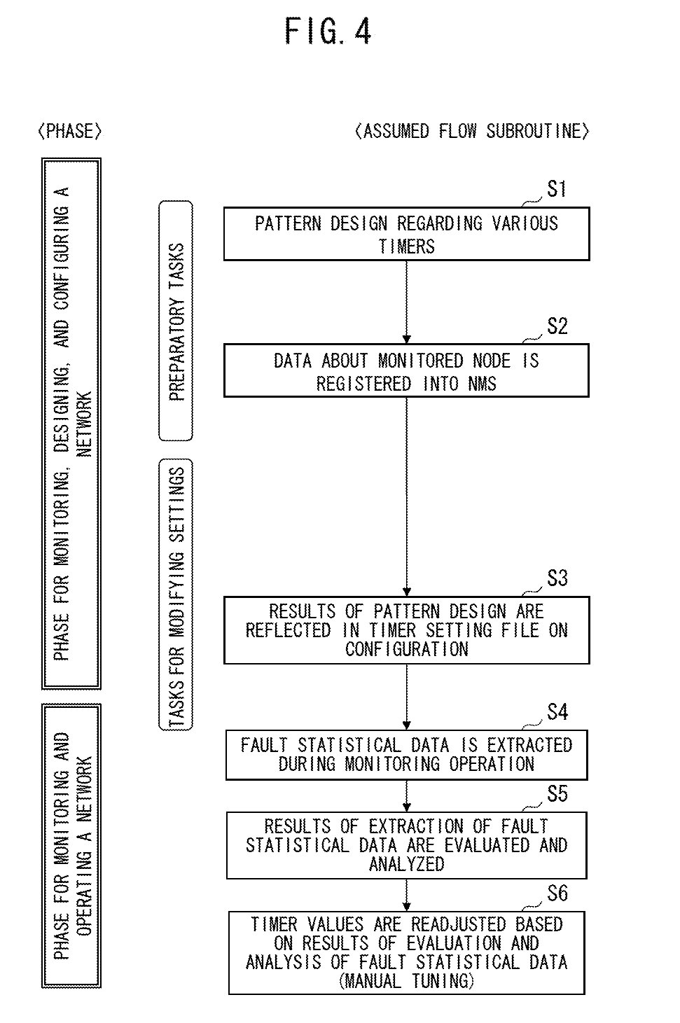

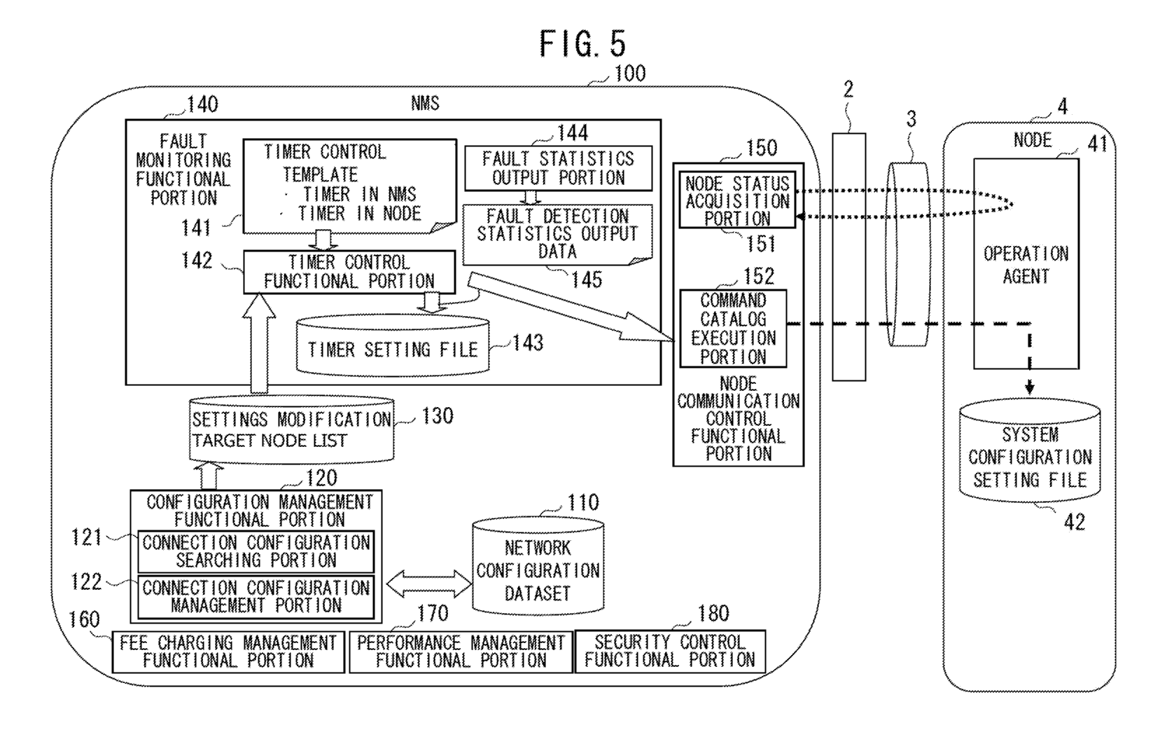

FIG. 5 illustrates an example of structure of a system associated with one embodiment of the present invention. This system has a network management system (NMS) 100 similar to the prior art network management system 1 of the system already described in connection with FIG. 2.

In FIG. 5, the network management system 100 has a configuration management function 120, a fault monitoring functional portion 140, a node communication control functional portion 150, a fee charging management functional portion 160, a performance management functional portion 170, and a security control functional portion 180.

The configuration management functional portion 120 has a connection configuration management portion 122 and a connection configuration searching portion 121. The connection configuration management portion 122 manages the whole configuration of a large-scale private IP network including a node 2, a link 3, and a node 4 as a network configuration dataset 110. The connection configuration searching portion 121 searches the network configuration dataset 110 and creates a setting modification target node list 130.

The fault monitoring functional portion 140 finds values of timers in the network management system 100 and in the node 4 based on a timer control template 141 and on the setting modification target node list 130. The monitoring functional portion 140 has a timer control functional portion 142 for setting the value of the timer in the network management system 100 into a timer setting file 143 such that the timer values found as described above are reflected substantially simultaneously. Furthermore, the timer control functional portion 142 requests a command catalog execution portion 152 included in the node communication control functional portion 150 to communicate with the node 4. In addition, the fault monitoring functional portion 140 has a fault statistics output portion 144 for producing fault detection statistics output data 145.

The node communication control functional portion 150 has a node status acquisition portion 151 for acquiring information about the status of the node 4 by periodically polling the operation agent 41 of the node 4 via the node 2 and link 3, and the command catalog execution portion 152 for distributing a command catalog to the system configuration setting file 42 from the node 2 and link 3 via the operation agent 41 of the node 4. The node status acquisition portion 151 corresponds to an operation manager.

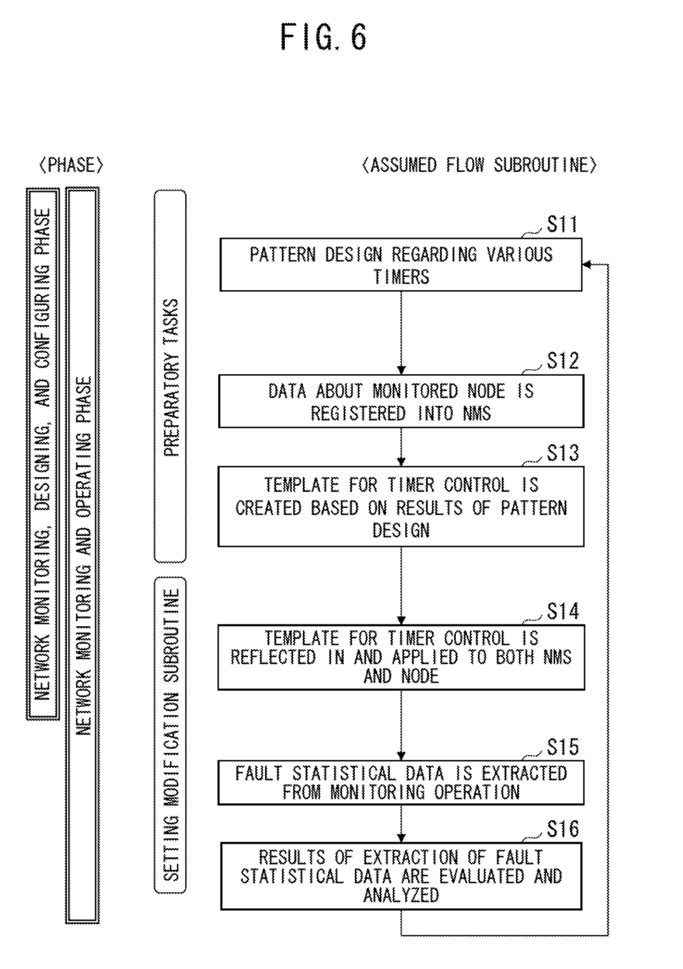

FIG. 6 is a flowchart illustrating a fault monitoring subroutine according to one embodiment of the present invention. In this subroutine, a network monitoring, designing, and configuring phase and a network monitoring and operating phase overlap with each other. In these phases, a set of preparatory tasks and a setting modification subroutine are performed.

In the set of preparatory tasks, patterns regarding various timers are designed (step S11), and data about the monitored node is registered into the network management system 100 (step S12). The designed patterns are registered as the network configuration dataset 110.

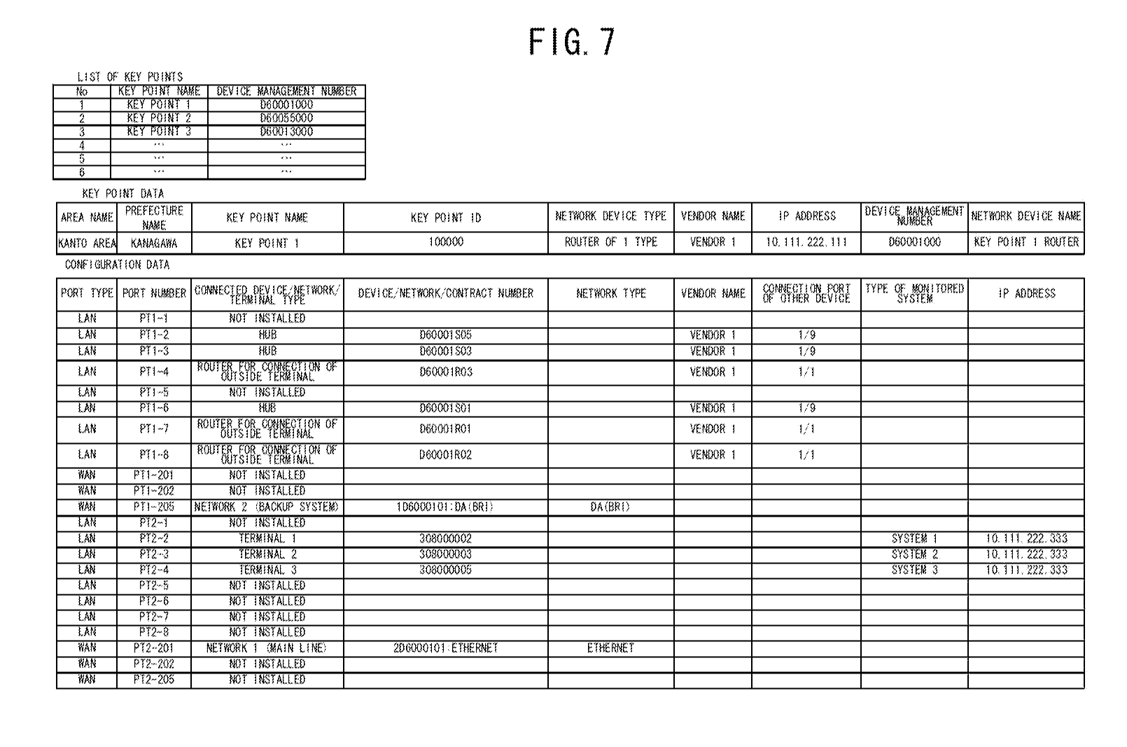

FIG. 7 is a diagram illustrating an example of a structure of the network configuration dataset 110. The configuration dataset 110 includes: a list of key points including the items of serial number (No), key point name, and device management number; a key point dataset including data items about each key point (e.g., name of area, name of prefecture, name of key point, ID of key point, type of network device, vendor's name, IP address, device management number, and name of network device); and configuration datasets about the key points (e.g., the items of port type, port number, connected device/network/terminal type, device/network/contract number, circuit class, vendor's name, connection port of other device, type of handled system, and IP address).

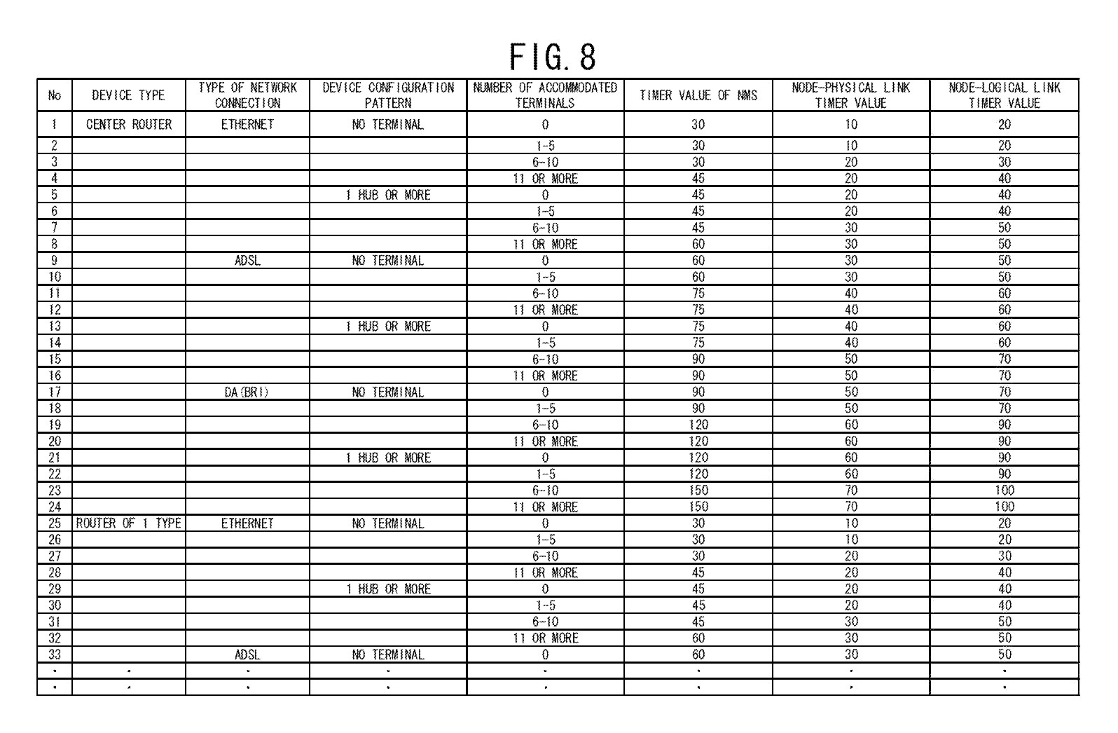

Referring back to FIG. 6, one of the preparatory tasks is performed. That is, the timer control template 141 is created based on the results of designing the patterns (step S13). FIG. 8 is a diagram illustrating an example of a structure of the timer control template 141. The diagram includes the items of serial number (No), device type, type of network connection, device configuration pattern, number of accommodated terminals, timer value of network management system, node-physical link timer value, and node-logical link timer value.

Referring back to FIG. 6, in the setting modification subroutine, the values of various timers are found from the timer control template 141 and simultaneously reflected in and applied to both the network management system 100 and node 4 (step S14).

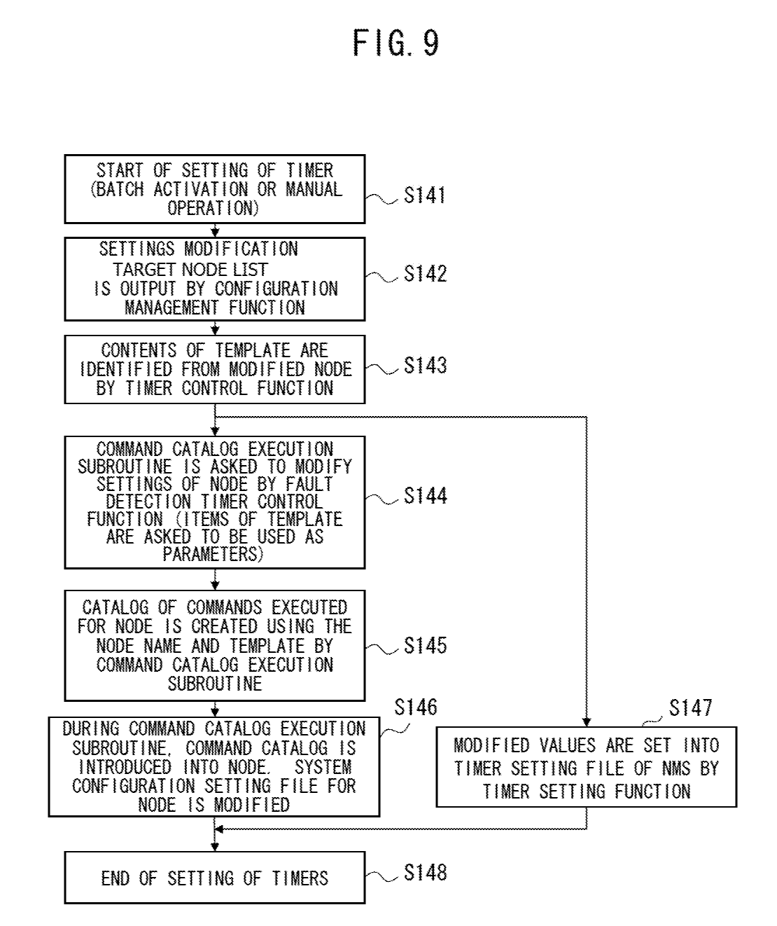

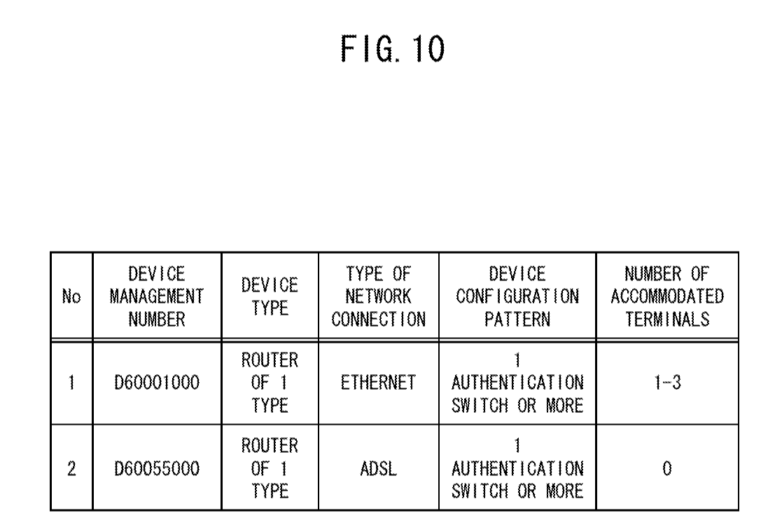

FIG. 9 is a flowchart illustrating an example of implementation of the setting modification subroutine. In the subroutine of FIG. 9, when the setting of a timer is started by batch activation or by a manual operation (step S141), the connection configuration searching portion 121 of the configuration management functional portion 120 searches the network configuration dataset 110, creates the setting modification target node list 130, and produces an output indicating the result (step S142). FIG. 10 is a diagram illustrating an example of the structure of the setting modification target node list 130. The list includes the items of serial number (No), device management number, device type, type of network connection, device configuration pattern, and number of accommodated terminals.

Referring back to FIG. 9, the timer control functional portion 142 of the fault monitoring functional portion 140 identifies the contents (the values of the various timers) from the timer control template 141 for the nodes to be modified, the nodes listed in the setting modification target node list 130 (step S143). That is, the functional portion 142 successively identifies the timer values corresponding to the device type, type of connection of network, device configuration pattern, and number of accommodated terminals of the node that is to be modified from the timer control template 141 and identifies the values of the timers in the network management system 100 and in the node 4.

Then, the timer control functional portion 142 of the fault monitoring functional portion 140 asks the command catalog execution portion 152 of the node communication control functional portion 150 to modify the settings of the node 4. In this operation, the contents of the timer control template 141 are used as parameters (step S144).

Then, the command catalog execution portion 152 of the node communication control functional portion 150 creates a catalog of commands to be executed for the node 4, using the applicable node name and the contents of the timer control template 141 (step S145).

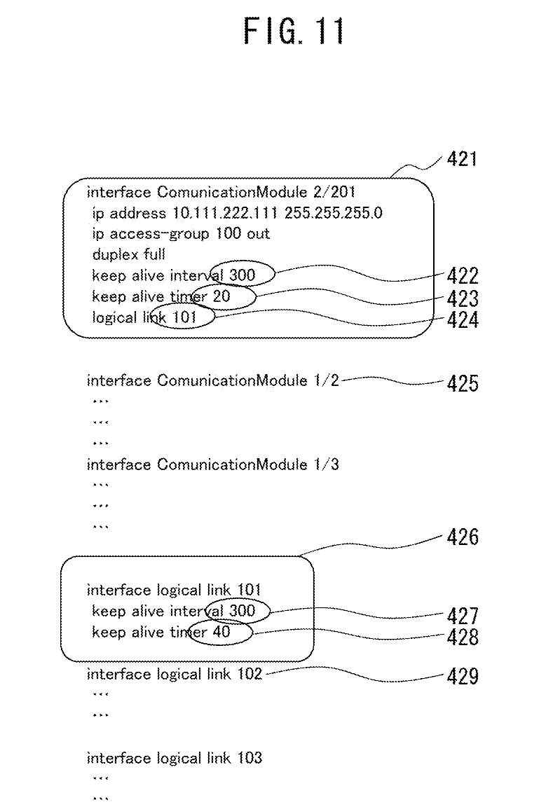

Then, the command catalog execution portion 152 of the node communication control functional portion 150 introduces the catalog of commands into the node 4 and modifies the system configuration setting file 42 in the node 4 (step S146). FIG. 11 illustrates an example of the structure of the system configuration setting file 42 within the node 4. In a block 421 of the file for setting a physical link, the value of a “keep alive interval” of the physical link is set as indicated by 422. Monitoring of the keep alive interval of the physical link times out after a period that is set as indicated by 423. The value of a logical link corresponding to the physical link is set as indicated by 424. Another physical link is set as indicated by 425. In a block 426 of the file for setting a logical link, the value of the keep alive interval of the logical link is set as indicated by 427. Monitoring of the keep alive interval of the logical link times out after a period that is set as indicated by 428. Another logical link is set as indicated by 429.

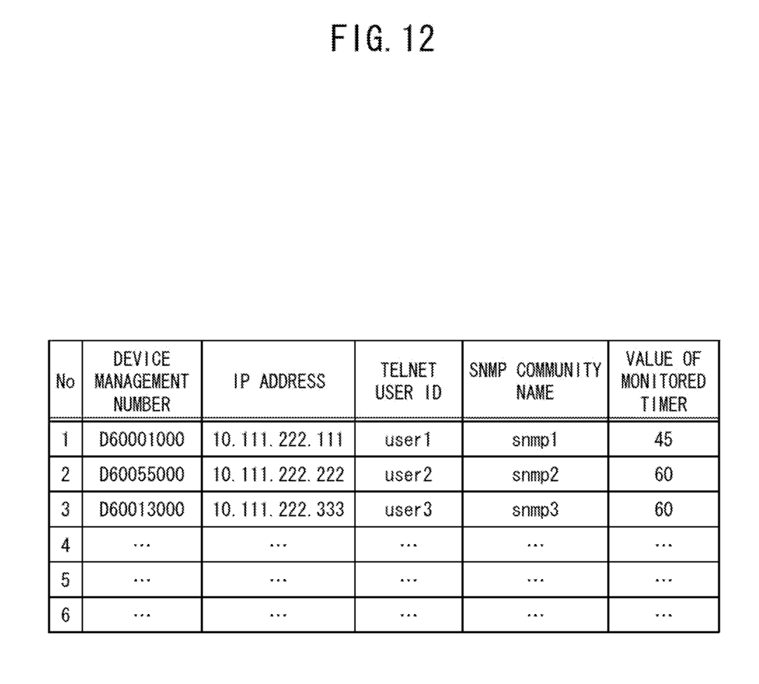

Referring back to FIG. 9, the timer control functional portion 142 of the fault monitoring functional portion 140 sets a modified value into the timer setting file 143 in the network management system 100 (step S147) and modifies the system configuration setting file 42 in the node 4 (step S146). The timer control functional portion 142 sets a modified value into the timer setting file 143 in the network management system 100 (step S147), thus terminating the setting of the timer (step S148). FIG. 12 is a diagram illustrating an example of structure of the timer setting file 143 within the network management system 100. Values are set into the items of serial number (No), device management number, IP address, telnet user ID, SNMP community name, and value of monitored timer.

The timer control functional portion 142 of the fault monitoring functional portion 140 causes the values of the various timers to be repetitively reflected in a batch in other nodes with similar designs.

Furthermore, the timer control functional portion 142 of the fault monitoring functional portion 140 may separate the effects of the monitoring of carrier-dependent unmonitored devices as a different design pattern by incorporating the conditions of the quality of the communication between the node and the network management system into the pattern of design of the node, the quality being dependent on the device gaining access to the carrier network. Consequently, what is transmitted may be limited to an optimum notification message desired for the classification of faults.

After the processing of the subroutine for modifying the settings as described so far, program control returns to the subroutine of FIG. 6. The fault statistics output portion 144 extracts fault statistical data derived by the monitoring operation (step S15), and evaluates and analyzes the results of the extraction (step S16). Then, program control goes back to step S11, where the patterns are designed.

The processing described so far causes the values of the timers in the network management system 100 and node 4 to be set in a batch-by-batch activation or a manual operation. Alternatively, the timer values may be set dynamically whenever a polling operation is performed.

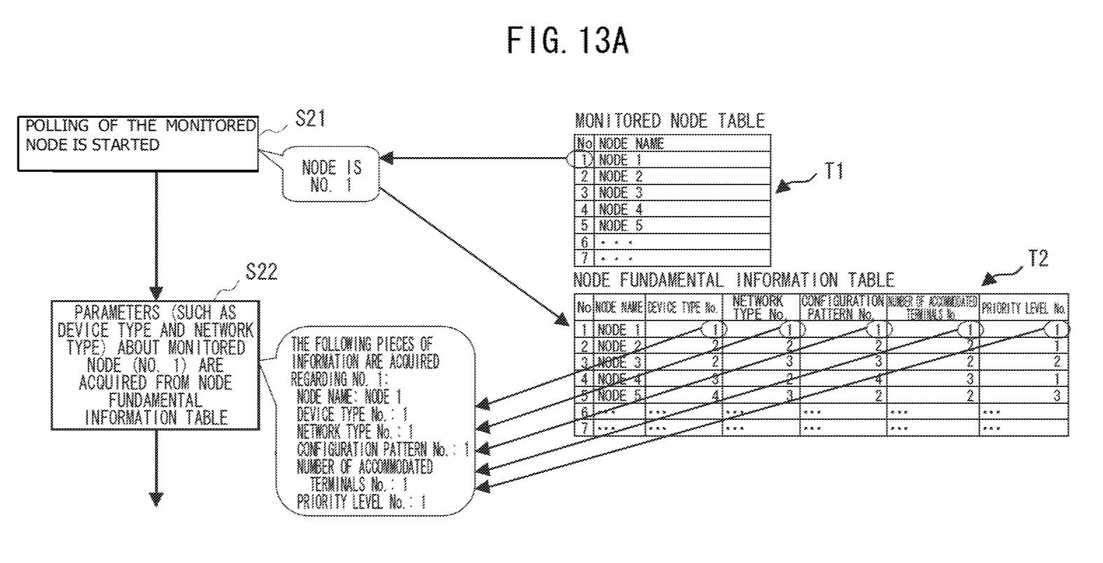

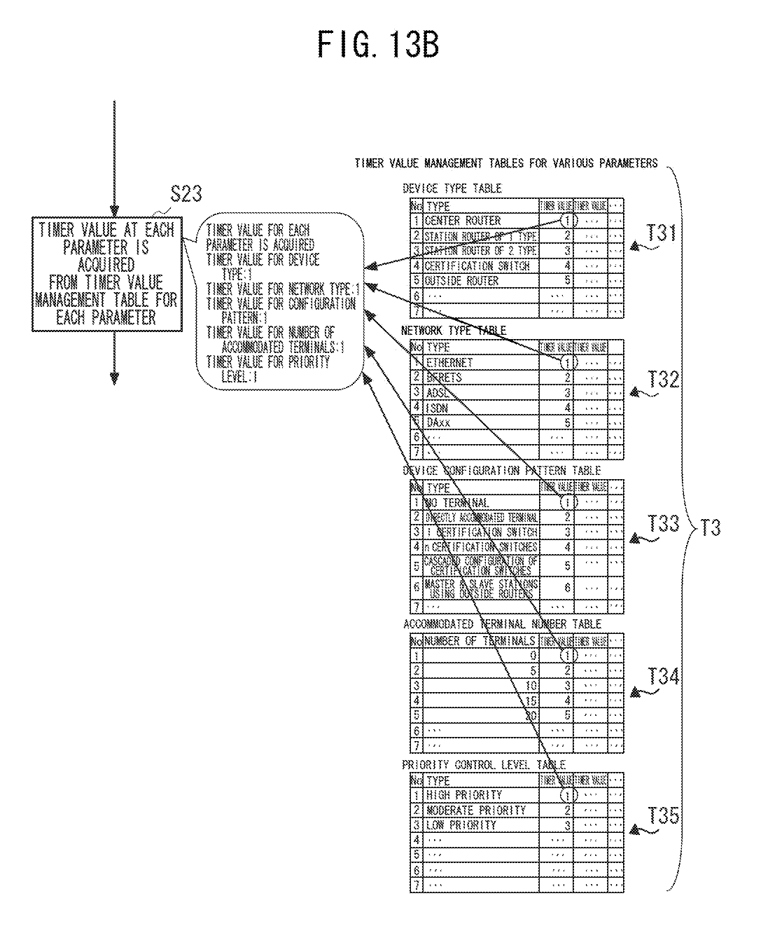

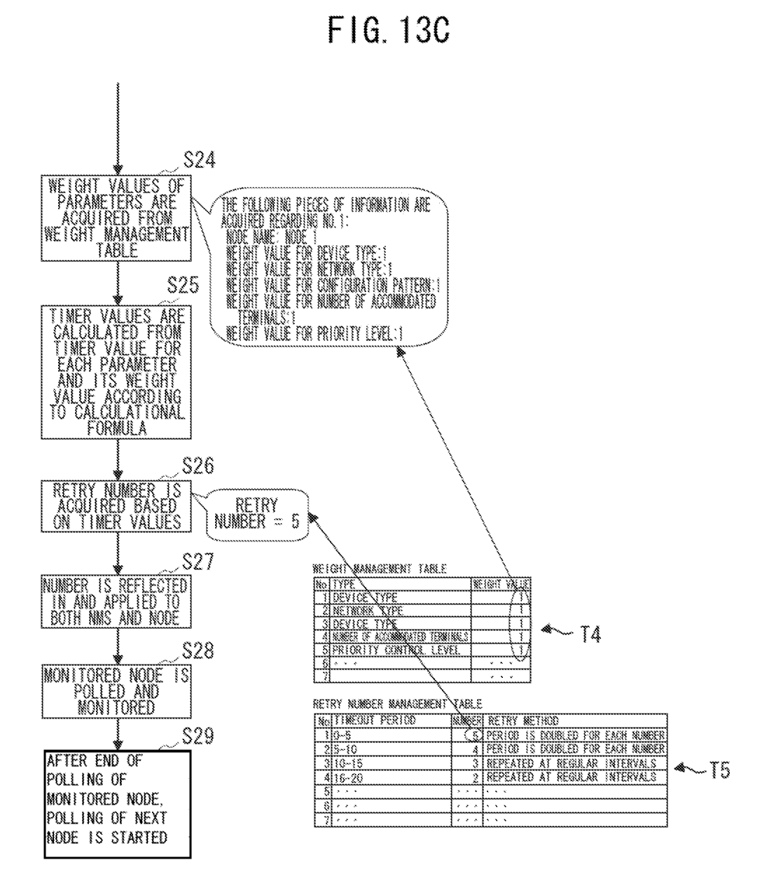

FIG. 13 is a flowchart illustrating an example of processing performed when the timer values are set dynamically. In this embodiment, another method of configuring the timer control template 141 may be implemented using a plurality of tables rather than a single table as also illustrated.

Referring to FIG. 13, when the polling of the monitored node is started (step S21), parameters (such as device type and network type) regarding the monitored node (No. 1) listed in a monitored node table T1 are acquired from a node fundamental information table T2 (step S22).

Then, timer values are acquired for each individual parameter from a timer value management table set T3 for each individual parameter (step S23). The table set T3 includes a device type table T31, a network type table T32, a device configuration pattern table T33, an accommodated terminal number table T34, and a priority control level table T35.

Weight values for the respective parameters are acquired from a weight management table T4 (step S24). Where no weights are used in later computation, this processing step is omitted.

Timer values are then calculated according to a given calculation formula from the timer values at each parameter and from the weight values (step S25). The following formulas may be used as the given calculation formula.

timer value=timer value at a specific device type+timer value at a specific network type+timer value for a device configuration pattern+timer value corresponding to the number of accommodated terminals+timer value at a priority control level (1)

timer value=timer value at a specific device type×weight+timer value at a specific network type×weight+timer value for a device configuration pattern×weight+timer value corresponding to the number of accommodated terminals×weight+timer value at a priority control level×weight (2)

timer value=[timer value at a specific device type|timer value at a specific network type|timer value for a device configuration pattern|timer value corresponding to the number of accommodated terminals|timer value at a priority control level], (3)

timer value=[timer value at a specific device type×weight|timer value at a specific network type×weight|timer value for a device configuration pattern×weight|timer value corresponding to the number of accommodated terminals×weight|timer value at a priority control level×weight]. (4)

Then, a retry number is acquired from a retry number management table T5 based on the found timer value (step S26).

Then, the found timer value is reflected in and applied to both the network management system 100 and the node 4 (step S27).

Then, the monitored node is polled and monitored (step S28). After the completion of the monitoring of the node, the polling of the next node is started and monitored (step S29).

A value indicating that the node is not monitored may be defined in the timer value management table T3 for each parameter. Calculation of each timer value may be nullified by nullifying the parameter values (e.g., set to “100”) in the node fundamental information table T2 for the node whose timer settings may be made invalid.

As described so far, in the network management system including a database having network type information, information about connection configurations, and information about priority control, the timer values regarding operations on the node and a command sequence for the operations may be modified based on design pattern information (such as network type information, connection configuration information, and information about priority control levels), as well as on the information about the type of the node. Consequently, when large-scale private IP networks having varied machine types, networks, and levels of priority control are managed, it is possible to circumvent frequent unwanted communication timeouts and prolonged operation waiting times.

New timer control templates 141 for individual design patterns for modifying the timer value settings regarding physical/logical link faults detected by the node are prepared for a command catalog execution portion 152 that issues command catalogs to the node from the network management system. As a consequence, when modifications are made to a large-scale private IP network (such as variations in the network configuration, addition of a carrier network, addition of a different network type, addition of a different machine type, or the like), the operator may easily modify the timer values of the node by making use of the network management system.

It is possible to cause the effects of monitoring of a carrier-depending unmonitored device to be isolated as a different design pattern by incorporating quality conditions of the communication between the node depending on a carrier network access device (such as an ADSL modem or protective device) and the network management system into the node design pattern. What is transmitted may be limited to optimum information messages desired for the classification of faults.

The present invention has been described so far using preferred embodiments. While specific examples have been illustrated in explaining the invention, various modifications and changes may be made thereto without departing from the broad gist and scope of the present invention delineated by the appended claims. That is, it should not be construed that the present invention is limited by the details of the specific examples and/or the accompanying drawings.

1. A method of network management comprising:
identifying a node, whose settings are to be modified, from design pattern information about a network to be managed;
finding values of various timers in the network management system and in the node whose settings are to be modified for the identified node based on a template for timer control; and
causing the found values of the timers to be reflected simultaneously in the network management system and in the node whose settings are to be modified.

2. A method of network management as set forth in claim 1, wherein the values of the various timers are repeatedly reflected in a batch for a plurality of nodes which have the same design pattern and whose settings are to be modified.

3. A method of network management as set forth in any one of claims 1 and 2, wherein effects of monitoring of a carrier-dependent device not to be monitored are isolated as a different design pattern by incorporating conditions of quality of communication between a node depending on a carrier network access device and the network management system into design patterns for nodes, and limiting transmitted information to optimum information messages necessary for classification of faults.

4. A network management system comprising:
identifying a node, whose settings are to be modified, from design pattern information about a network to be managed;
finding values of various timers included in the network management system and in the node whose settings are to be modified about the identified node based on a template for timer control; and
causing the found values of the timers to be reflected simultaneously in the network management system and in the node whose settings are to be modified.

5. A network management system as set forth in claim 4, wherein the values of the timers are repeatedly reflected in a batch in a plurality of nodes which have the same design pattern and whose settings are to be modified.

6. A network management system as set forth in any one of claims 4 and 5, wherein effects of monitoring of a carrier-dependent device not to be monitored are isolated as a different design pattern by incorporating conditions of quality of communication between a node depending on a carrier network access device and the network management system into design patterns for nodes, and transmitting only optimum information messages necessary for classification of faults.
